(19) United States
(12) Patent Application Publication
(10) Pub. No.: US 2023/0274042 A1
(43) Pub. Date: Aug. 31, 2023

(54) ENGINEERING A PHYSICAL SYSTEM INVOLVING ENHANCED CONSISTENCY OF ENGINEERING-RELATED INFORMATION

(71) Applicant: Siemens Industry Software GmbH, Zürich (CH)

(72) Inventor: Nikolay Entin, Stuttgart (DE)

(21) Appl. No.: 18/108,766

(22) Filed: Feb. 13, 2023

Related U.S. Application Data
(63) Continuation of application No. PCT/EP2022/054960, filed on Feb. 28, 2022.

(51) Int. Cl. G06F 30/12

(52) U.S. Cl. CPC G06F 30/12; G06F 2113/02

(57) ABSTRACT

A computer-implemented method and system including providing engineering information in an engineering database, providing lifecycle information in a lifecycle database, providing a respective first connector for connecting a respective engineering artifact comprised by the engineering information directly or indirectly with a respective lifecycle artifact comprised by the lifecycle information, wherein the respective first connector is stored in the engineering database, providing a respective second connector for connecting the respective lifecycle artifact directly or indirectly with the respective engineering artifact, wherein the respective second connector is stored in the lifecycle database, providing a deletion of the respective first connector; and deleting the respective second connector.

### CROSS REFERENCE TO RELATED APPLICATIONS

This application is a continuation under 37 C.F.R. § 1.53(b) of PCT PCT/EP2022/054960 filed on Feb. 28, 2022, which is hereby incorporated in its entirety by reference.

### FIELD

The present disclosure is directed to engineering systems, engineering management systems, systems engineering systems, and similar systems, such as computer-aided design (CAD), computer-aided manufacturing (CAM), computer-aided engineering (CAE), and electronic design automation (EDA), that are used to design, integrate, and manage physical systems, such as machines, structures, and other items, including bridges, tunnels, roads, vehicles, and buildings. The present disclosure is further directed, in general, to product lifecycle management (PLM) systems, application lifecycle management (ALM) systems, for example for software, artifact information systems, and similar systems, that are used to create, use, and manage data for products comprising software and artifacts and other items. The mentioned systems are collectively referred to herein as product systems. Further, the present disclosure is directed, in general, to the interplay of the mentioned engineering systems and the PLM or ALM systems.

### BACKGROUND

Product systems may include stored content associated with physical systems and product lifecycle information of physical systems. Such content may include engineering information and lifecycle information of the physical system to be engineered.

Currently, there exist product systems and solutions that support engineering a physical system. Such product systems may benefit from improvements.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Variously disclosed embodiments include data processing systems and methods that may be used to facilitate engineering a physical system, involving enhanced consistency of engineering-related information.

According to a first aspect, a computer-implemented method of engineering a physical system may include: providing engineering information in an engineering database, the engineering information being related to physical, mechanical, electrical, electronic, hydraulic, thermal, control, electric power and/or process-oriented information of the physical system; providing lifecycle information in a lifecycle database, the lifecycle information being related to the conception, requirements, uses cases, issues, design, realization and/or service information of the physical system; providing a respective first connector for connecting a respective engineering artifact included by the engineering information directly or indirectly with a respective lifecycle artifact included by the lifecycle information, wherein the respective first connector is stored in the engineering database; providing a respective second connector for connecting the respective lifecycle artifact directly or indirectly with the respective engineering artifact, wherein the respective second connector is stored in the lifecycle database; providing a deletion of the respective first connector; and deleting the respective second connector.

According to a second aspect, a computer system may be arranged and configured to execute the steps of the computer-implemented method according to the first aspect.

According to a third aspect, a computer program product may include computer program code that, when executed by the computer system according to the second aspect, causes the computer system to carry out the method according to the first aspect.

According to a fourth aspect, a computer-readable medium may include the computer program product according to the third aspect. By way of example, the described computer-readable medium may be non-transitory and may further be a software component on a storage device.

### BRIEF DESCRIPTION OF THE DRAWINGS

FIG. 1 depicts a functional block diagram of an example system that facilitates engineering a physical system, for example involving enhanced consistency of engineering-related information, in a product system according to an embodiment.

FIGS. 2-7 depict various example scenarios of engineering information, lifecycle information and connectors in the context of facilitating engineering a physical system, for example involving enhanced consistency of engineering-related information, in a product system according to an embodiment.

FIGS. 8-9 depict two sample UIs that facilitate engineering a physical system, for example involving enhanced consistency of engineering-related information, in a product system according to an embodiment.

FIG. 10 depicts a flow diagram of an example methodology that facilitates engineering a physical system, for example involving enhanced consistency of engineering-related information, in a product system according to an embodiment.

FIG. 11 depicts a block diagram of a data processing system in which an embodiment may be implemented.

### DETAILED DESCRIPTION

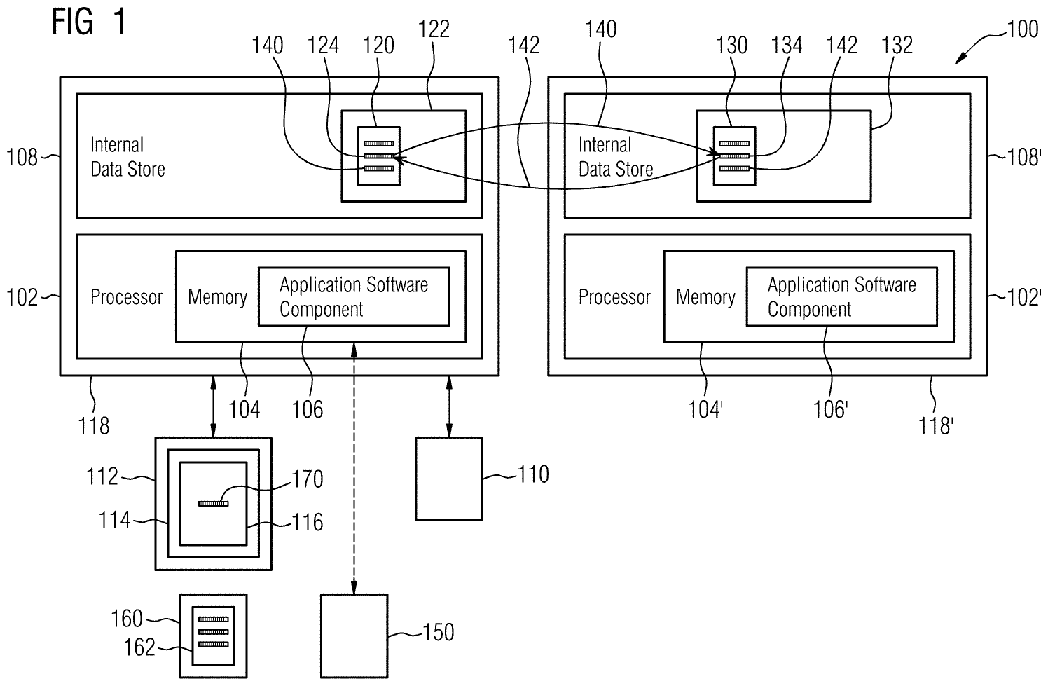

With reference to FIG. 1, a functional block diagram of an example data processing system 100 is depicted that facilitates engineering a physical system 150. The data processing system 100 may, in some examples, include an engineering system 118 and a product lifecycle management system 118′. The engineering system 118 and the product lifecycle management system 118′ may, by way of example, each include at least one processor 102, 102′ that is configured to execute at least one respective application software component 106, 106′ from a respective memory 104, 104′ accessed by the respective processor 102, 102′. The respective application software component 106, 106′ may be configured (i.e., programmed) to cause the respective processor 102, 102′ to carry out various acts and functions described herein. For example, the described application software component 106, 106′ may include and/or correspond to one or more components of an engineering software application or to a PLM or ALM software application that is configured to generate and store product data in a data store 108, 108′ such as a database, respectively.

In some examples, the engineering system 118 may allow for the engineering a physical system 150 by providing corresponding functionalities to a user and by creating, amending, or managing corresponding engineering information 120 relating to the physical system 150. The product lifecycle management system 118′ may, e.g., allow for the management of lifecycle information 130 by providing corresponding functionalities to a user and by creating, amending, or managing corresponding lifecycle information 130 relating to the physical system 150. By way of example, the engineering information 120 may relate to physical, mechanical, electrical, electronic, hydraulic, thermal, control, electric power and/or process-oriented information of the physical system. Further, the lifecycle information 130 may, e.g., relate or include to the conception, requirements, uses cases, issues, design, realization and/or service information of the physical system 150. In further examples, the lifecycle information 130 may, e.g., include data records representing/storing data corresponding to parts, tools, documents, process descriptions, templates, materials, requirements specifications, software products, or software applications relating to the physical system 150, respectively. In further embodiments, the lifecycle information 130 may include test information, test cases or test management information with respect to the physical system 150, whereby the test information, test cases or test management information may be used to qualify the physical system 150 as compliant with certain requirements or specifications or to find issues of the physical system 150. Such test information, test cases or test management information may further be available for different variants of the physical system 150, e.g., standard, premium, luxury variants of a car, low-, middle, high-power output machines, etc. An issue identified for at least one variant of the physical system 150 using the test information, test cases or test management information may equally apply to the other variants of the physical system 150. Hence, an issue identified for at least one variant of the physical system 150 may easily be checked or verified for the other variants of the physical system 150.

In some examples, the physical system 150 may include or be a sensor, an actuator, such as an electric motor, a valve or a robot, an inverter supplying an electric motor, a gear box, a programmable logic controller (PLC), a communication gateway, and/or other parts or components relating to industrial automation products and industrial automation in general. The physical system 150 may be part of a complex production line or production plant, e.g., a bottle filing machine, conveyor, welding machine, welding robot, etc. In some examples, the physical system 150 may be a smartphone, smartwatch, handheld, pad, laptop or the like, or a desktop device, e.g., including desktop computers, or other “smart” devices, e.g., smart television sets, fridges, home or industrial automation devices, wherein smart television sets may e.g., be a television set with integrated Internet capabilities or a set-top box for television that offers more advanced computing ability and connectivity than a contemporary basic television set. Further, by way of example, the physical system 150 may include or be any machine, structure, or other items, including bridges, tunnels, roads, vehicles, and buildings, that may be engineered.

Examples of engineering systems that may be adapted to include the some of the engineering features described herein may include Simcenter Amesim, an application produced by Siemens Industry Software NV, of Leuven, Belgium, the NX suite of applications or Solid Edge applications produced by Siemens Industry Software Inc., of Plano, Tex., USA or the Totally Integrated Automation (TIA) Portal, an application produced by Siemens Aktiengesellschaft, of Munich, Germany. Examples of PLM systems that may be adapted to support the engineering features described herein may include the Active Workspace features of Teamcenter, an application produced by Siemens Industry Software Inc., of Plano, Tex., USA. Examples of ALM systems that may be adapted to support the engineering features described herein may include Polarion ALM, an application produced by Siemens Industry Software GmbH, of Zurich, Switzerland. However, the systems and methods described herein may be used in other product systems (e.g., PLM, PDM, ALM systems) and/or any other type of system that generates and stores product data in a database. Also, examples of databases that may be used as one or more data stores described herein include database server applications such as Oracle, Microsoft SQL Server, or any other type of data store that is operative to store data records.

By way of example, the data processing system 100 may be cloud-based, internet-based and/or be operated by a provider providing engineering support. The user may be located close to the data processing system 100 or remote to the data processing system 100, e.g., anywhere else, e.g., using a mobile device for connecting to the data processing system 100, e.g., via the internet, wherein the user's device may include an input device 110 and a display device 112. In some examples, the data processing system 100, esp. the engineering system 118 and/or the product lifecycle management system 118′, may be installed and run on a user's device, such as a computer, laptop, pad, on-premises computing facility, or the like.

It may be difficult and time-consuming to engineer a physical system 150 in complex, production engineering, PLM or ALM environments. For example, amendments may be made to some of the engineering information 120 or to some of the information related to the physical system 150 stored in an engineering database 122 and these amendments may not be taken into account by the corresponding lifecycle information 130 or information related to the physical system 150 stored in a lifecycle database 132. However, consistence between the engineering information 120 and lifecycle information 130 of the physical system 150 may be essential to enable a successful engineering process and a successful design or production or manufacture of the physical system 150. According to other approaches, achieving consistency between the engineering information 120 and the lifecycle information 130 of the physical system 150 may require many consciously and carefully performed manual steps that is an error-prone, slow, and not efficient process.

To enable the enhanced engineering of a physical system 150, the described data processing system 100 or, e.g., the engineering system 118, may include at least one input device 110 and at least one display device 112 (such as a display screen). The described processor 102 may be configured to generate a graphical user interface (GUI) 114 through the display device 112. Such a GUI may include GUI elements such as buttons, links, search boxes, lists, text boxes, images, scroll bars) usable by a user to provide inputs through the input device 110 that cause managing artifact information.

In some examples, the application software component 106 and/or the processor 102 may be configured to provide engineering information 120 in an engineering database 122, the engineering information 120 being related to physical, mechanical, electrical, electronic, hydraulic, thermal, control, electric power and/or process-oriented information of the physical system 150. The engineering database 122 may, by way of example, be included by the data store 108 of the engineering system 118 or more generally of the data processing system 100. In some examples, the engineering information 120 may characterize the geometric shape, the surface quality, the stiffness, electric, magnetic and or thermal conductivity of the physical system 150. Further, the engineering information 120 may include information on controlling the physical system 150 or on controlling a process, e.g., a production process, using the physical system 150. The engineering information 120 may directly relate to the physical system 150 or to one or more components of the physical system 150.

In some examples, the engineering database 122 may be included by an engineering system 118.

By way of example, the application software component 106 and/or the processor 102 may further be configured to provide lifecycle information 130 in a lifecycle database 132, the lifecycle information 130 being related to the conception, requirements, uses cases, issues, design, realization and/or service information of the physical system 150. Herein, the conception may relate to information on the physical system 150 that has been created during the ideation, i.e., in an early phase of the creation of the physical system 150. The requirements may include or be a physical or functional need that the physical system 150 aims to satisfy. The requirements may, e.g., describe any necessary (or sometimes desired) function, attribute, capability, characteristic, or quality of the physical system 150 for it to have value and utility to a customer, organization, internal user, or other stakeholder. By way of example, the requirements may define characteristics that the physical system 150 shall have or comply with, such as output power, maximum weight, surface quality, compliance with safety regulations, etc. Use cases of the physical system 150 may include a usage scenario for the physical system 150, such as the employment of the physical system 150 at a certain industrial environment, e.g., a conveyor, paper machine, etc. that may influence or determine certain properties or requirements of the physical system 150. Use cases may further include potential scenarios in which the physical system 150 receives an external request, such as user input or sensor or a control data and responds to it. Hence, such a potential scenario may involve a response function that the physical system 150 has in reply to given input data. Issues may, by way of example, relate to potential deficiencies or customer complaints with respect to the physical system 150 or functionalities or components of the physical system 150. Hence, such issues may also influence or determine certain properties or requirements of the physical system 150. Further, the design may relate to the geometrical, visual of physical appearance of the physical system 150. The design may further be or include a plan or specification for the construction of the physical system 150 or for the implementation of an activity or process relating to the physical system 150, or the result of that plan or specification in the form of a prototype, product, or process. Herein, the design may need to satisfy certain goals and constraints, such as the requirements, and may need to take into account aesthetic, functional, economic, or socio-political considerations, and is expected to interact with a certain environment. Examples of designs include architectural blueprints, engineering drawings, business processes, circuit diagrams, and sewing patterns. The realization may relate to the manufacturing or the production of the physical system 150 and, in some examples, include information on how to manufacture or produce the physical system 150 and how to achieve the desired characteristics of the physical system 150, such as surface quality so that compliance with the above-mentioned requirements may be achieved. Service information may describe how the physical system 150 needs to be serviced, e.g., which maintenance intervals apply, and which maintenance activities need to be carried out to allow for reliable and long-lived operation of the physical system 150.

In some examples, the lifecycle database 132 may be included by a product lifecycle management system 118′ that may be different from the engineering system 118. Accordingly, the engineering database 122 may be different from the lifecycle database 132 that are stored in different data stores 108, 108′, respectively. In further examples, the lifecycle database 132 may be stored in the same data store 108 as the engineering database 122 and the processor 102 may be used by both the engineering system 118 and the product lifecycle management system 118′.

Additionally, the lifecycle information 130 may include software documentation, software applications, complex data objects, work items, tasks, change requests, defects or test cases, source code of software products, images, videos, text, webpages, documentation, or any combination thereof, relating to the above-explained lifecycle information 130 of the physical system 150. Such lifecycle information 130 may, e.g., be used in the context of (agile) software or hardware development.

In some examples, the described engineering information 120 may be tightly connected to the described lifecycle information 130 and vice versa. For example, changes to the engineering information 120 may, in many cases, require changes to the lifecycle information 130 and vice versa. Hence, there may be an interplay between the engineering information 120 and the lifecycle information 130 that reflects the fact that both the engineering information 120 and the lifecycle information 130 may characterize the physical system 150 or parts of it.

In some examples, the application software component 106 and/or the processor 102 may further be configured to provide a respective first connector 140 for connecting a respective engineering artifact 124 included by the engineering information 120 directly or indirectly with a respective lifecycle artifact 134 included by the lifecycle information 130, wherein the respective first connector 140 is stored in the engineering database 122.

The respective engineering artifact 124 may, by way of example, characterize a respective component of the physical system 150, e.g., with respect to geometry or mechanical properties. The respective lifecycle artifact 134 may, e.g., accordingly characterize the corresponding requirements with respect to the respective component. In the engineering environment, e.g., in the engineering system 118, the engineering software application and/or the engineering database 124, there may be a respective first connector 140 connecting the respective engineering artifact 124 with the respective lifecycle artifact 134. This respective first connector 140 may be stored in the engineering database 124 and may therefore be understood as a one-way connector from the engineering database 124 to the lifecycle database 134, but not connecting in the opposite direction from the lifecycle database 134 to the engineering database 124. Herein, the connection established via the respective first connector 140 may be a direct connection of the respective engineering artifact 124 with the respective lifecycle artifact 134 or it may be an indirect connection of the respective engineering artifact 124 via some intermediate element with the respective lifecycle artifact 134. These two concepts are explained in more detail below.

By way of example, the application software component 106 and/or the processor 102 may further be configured to provide a respective second connector 142 for connecting the respective lifecycle artifact 134 directly or indirectly with the respective engineering artifact 124. The respective second connector 142 is stored in the lifecycle database 132.

In the lifecycle environment, e.g., in the product lifecycle system 118′, the ALM application and/or the lifecycle database 134, there may be a respective second connector 142 connecting the respective lifecycle artifact 134 with the respective engineering artifact 124. This respective second connector 142 may be stored in the lifecycle database 134 and may therefore be understood as a one-way connector from the lifecycle database 134 to the engineering database 124, but not connecting in the opposite direction from the engineering database 124 to the lifecycle database 134. Herein, the connection established via the respective second connector 142 may be a direct connection of the respective lifecycle artifact 134 with the respective engineering artifact 124 or it may be an indirect connection of the respective lifecycle artifact 134 via some other intermediate element with the respective engineering artifact 124. These two concepts are also explained in more detail below.

In some examples, the application software component 106 and/or the processor 102 may further be configured to provide a deletion of the respective first connector 140. The deletion of the respective first connector 140 may, e.g., be caused or triggered by the user of the engineering system 118 or the engineering database 124 who amends the respective engineering artifact 124 or some lifecycle data characterizing the respective engineering artifact 124. After this amendment, the respective lifecycle artifact 134 so far linked with the first connector 140 with the respective engineering artifact 124 may no longer fit to the respective engineering artifact 124 so that the respective first connector 140 may be deleted, e.g., by the user or automatically by the engineering system 118 that may detect an according amendment.

By way of example, the application software component 106 and/or the processor 102 may further be configured to delete the respective second connector 142. The deletion of the respective second connector 142 may contribute to keep the engineering information 120 in the engineering database 124 and the lifecycle information 130 in the lifecycle 134 consistent. After this deletion of the respective first connector 140 and of the respective second connector 142, both the engineering database 124 and the lifecycle database 134 may reflect that the respective lifecycle artifact 134 may no longer fit to the respective engineering artifact 124.

In some examples, the respective first connector 140 may directly link the respective engineering artifact 124 with the respective lifecycle artifact 134.

In these examples, the respective engineering artifact 124 stored in the engineering database 122 is directly linked via the respective first connector 140 with the respective lifecycle artifact 134 stored in the lifecycle database 132. As already mentioned above, the respective first connector 140 may be stored in the engineering database 122 and may only cover the connection of the respective engineering artifact 124 with the respective lifecycle artifact 134, but now vice versa. If the respective first connector 140 is deleted, the respective second connector 142 may also be deleted.

In such examples, the engineering database 122 or the engineering system 118 may only include engineering information 120, e.g., at least for the respective engineering artifact 124, whereas the corresponding lifecycle information 130 may only be stored in the lifecycle database 132. For example, an electric motor may be designed or engineered in the engineering system 118, wherein components of the electric motor, such as the stator, the rotor, the bearings, etc. including information on their respective geometry or surface quality may be stored as respective engineering artifacts 124 in the engineering database 122. The corresponding lifecycle information 130, such as the requirements with respect to geometry, surface quality, etc. of the electric motor or its components may be stored as corresponding lifecycle artifacts 134 and the lifecycle database 132. The respective first connector 140 may link the respective engineering artifact 124, e.g., the rotor of the electric machine, with the corresponding lifecycle artifact 134, e.g., the geometry requirements of the rotor.

The described direct connection between the engineering system 118 or the respective engineering artifact 124 with the lifecycle system 118′ or the respective lifecycle artifact 134 has the benefit that it may allow for synchronous communication, e.g., to consume the latest information, e.g., any updates with respect to the engineering system 118 or the respective engineering artifact 124 may be available to the lifecycle system 118′ or the respective lifecycle artifact 134. In some examples, the described direct connection may further allow for asynchronous operations, e.g., to process a traceability inside of the engineering system 118 or the respective engineering artifact 124 offline, and later the user may go online and synchronize made changes to the engineering system 118 or to the respective engineering artifact 124 with the lifecycle system 118′ or the respective lifecycle artifact 134. One noticeable aspect in this context is that for the enhanced traceability, links such as the respective first connector 140 may be managed. And links may, in some examples, be understood to be always “online”, e.g., such that at the time of the operation execution both the start point, and end point of the link should be accessible, even if the rest of the operations could be done offline. E.g., a link, e.g., the respective first connector 140, may be created, amended or deleted in the engineering system 118 or the engineering database 122 while the engineering system 118 or the engineering database 122 (or the lifecycle system 118′ or the lifecycle database 132) is offline. While the respective first connector 140 may (locally) be stored in the engineering database 122, the corresponding information for the reversed link that is to be created, amended, or deleted accordingly, e.g., the respective second connector 142, may, in some examples, not be pushed to the lifecycle system 118′ or the lifecycle database 132 until the engineering system 118 or the engineering database 122 goes online. Once the engineering system 118 or the engineering database 122 is online, the information about the creation, amendment, or deletion of the respective first connector 140 may be pushed to the lifecycle system 118′ or the lifecycle database 132 that allows for the creation, amendment or deletion of the respective second connector 142. Corresponding considerations may, in some examples, apply to the indirect link of the respective engineering artifact 124 with the respective lifecycle artifact 134 via the respective engineering requirements information 126 using the respective first connector 140 that is described in the next paragraphs.

By way of example, the application software component 106 and/or the processor 102 may further be configured to provide respective engineering requirements information 126 related to the respective engineering artifact 124 in the engineering database 122, the respective engineering requirements information 126 being related to the conception, requirements, uses cases, issues, design, realization and/or service information of the physical system 150. The respective first connector 140 links the respective engineering artifact 124 with the respective lifecycle artifact 134 via the respective engineering requirements information 126. The link of the respective engineering artifact 124 with the respective engineering requirements information 126 is deleted.

In this example, the respective engineering artifact 124 stored in the engineering database 122 is indirectly linked via the respective first connector 140 with the respective lifecycle artifact 134 stored in the lifecycle database 132. The indirect link of the respective engineering artifact 124 with the respective lifecycle artifact 134 via the respective first connector 140 may be established by linking the respective engineering artifact 124 with the respective engineering requirements information 126 which is linked with the respective lifecycle artifact 134.

In some examples, the respective first connector 140 may be deleted by deleting the link of the respective engineering artifact 124 with the respective engineering requirements information 126.

In such an example, the engineering database 122 or the engineering system 118 may further include respective engineering requirements information 126 that may be related to the respective engineering artifact 124. Herein, the respective engineering requirements information 126 may at least partly coincide or overlap with the corresponding lifecycle artifact 134 stored in the lifecycle database 132. For example, an electric motor may be designed or engineered in the engineering system 118, wherein components of the electric motor, such as the stator, the rotor, the bearings, etc. including information on their respective geometry or surface quality may be stored as respective engineering artifacts 124 in the engineering database 122. Some or all of the corresponding lifecycle information 130, such as the requirements with respect to geometry, surface quality, etc. of the electric motor or its components may be stored both as respective engineering requirements information 126 in the engineering database 122 and as corresponding lifecycle artifacts 134 and the lifecycle database 132. The respective first connector 140 may link the respective engineering artifact 124, e.g., the rotor of the electric machine, with the respective engineering requirements information 126, e.g., the geometry requirements of the rotor, that is linked with the corresponding lifecycle artifact 134, e.g., the geometry requirements of the rotor.

Using such respective engineering requirements information 126 that is stored in the engineering database 122 may, in some examples, facilitate directly or more conveniently managing, e.g., simple aspects of, lifecycle information 130 in the engineering database 122 or the engineering system 118 while still benefiting from comprehensive, professional lifecycle management through the lifecycle database 132 or the lifecycle system 118′.

Using such respective engineering requirements information 126 may, in some examples, be particularly beneficial if the engineering database 122 and the lifecycle database 132 may not always be connected to each other with a sufficiently fast data connection allowing for fast data transfer and data synchronization. For example, network interruptions may occur, or a server used for providing the engineering data base 122 or the engineering system 118 and/or the lifecycle database 132 or the lifecycle system 118′ may not always be available. Such unreliable data connection scenarios may make consistency and traceability of engineering-related information very challenging.

In further examples, the deletion of the respective first connector 140 may further include deleting the link of the respective engineering requirements information 126 with the respective lifecycle artifact 134 and/or further include deleting the respective engineering requirements information 126, e.g., if the respective engineering requirements information 126 is no more linked with other engineering artifacts 124 and/or with the lifecycle artifacts 134.

In some examples, the respective second connector 142 directly links the respective lifecycle artifact 134 with the respective engineering artifact 124.

In these examples, the respective lifecycle artifact 134 stored in the lifecycle database 132 is directly linked via the respective second connector 142 with the respective engineering artifact 124 stored in the engineering database 122. As already mentioned above, the respective second connector 142 may be stored in the lifecycle database 132 and may only cover the connection of the respective lifecycle artifact 134 with the respective engineering artifact 124, but now vice versa. If the respective first connector 140 is deleted, the respective second connector 142 may also be deleted.

In such examples, the lifecycle database 132 or the lifecycle system 118′ may only include lifecycle information 130, e.g., at least for the respective engineering artifact 124, whereas the corresponding engineering information 120 may only be stored in the engineering database 122. In the context of the above example of an electric motor designed or engineered in the engineering system 118, the components of the electric motor, such as the stator, the rotor, the bearings, etc. including information on their respective geometry or surface quality may be stored as respective engineering artifacts 124 in the engineering database 122. The corresponding lifecycle information 130, such as the requirements with respect to geometry, surface quality, etc. of the electric motor or its components may be stored as corresponding lifecycle artifacts 134 and the lifecycle database 132. The respective second connector 142 may link the respective lifecycle artifact 134, e.g., the geometry requirements of the rotor, with the corresponding engineering artifact 124, e.g., the rotor of the electric machine.

The described direct connection between the lifecycle system 118′ or the respective lifecycle artifact 134 with the engineering system 118 or the respective engineering artifact 124 has the benefit that it may allow for synchronous communication, e.g., to consume the latest information, e.g., any updates with respect to the lifecycle system 118′ or the respective lifecycle artifact 134 may be available to the engineering system 118 or the respective engineering artifact 124. In some examples, that the described direct connection may further allow asynchronous operations, e.g., to process a traceability inside of the lifecycle system 118′ or the respective lifecycle artifact 134 offline, and later the user may go online and synchronize made changes to the lifecycle system 118′ or to the respective lifecycle artifact 134 with the engineering system 118 or the respective engineering artifact 124. One noticeable aspect in this context is that for the enhanced traceability, links such as the respective second connector 142 may be managed. And links may, in some examples, be understood to be always “online”, e. g., such that at time of the operation execution both the start point, and end point of the link should be accessible, even if the rest of the operations could be done offline. E.g., a link, e.g., the respective first connector 140, may be created, amended or deleted in the engineering system 118 or the engineering database 122 while the engineering system 118 or the engineering database 122 (or the lifecycle system 118′ or the lifecycle database 132) is offline. While the respective first connector 140 may (locally) be stored in the engineering database 122, the corresponding information for the reversed link that is to be created, amended, or deleted accordingly, e.g., the respective second connector 142, may, in some examples, not be pushed to the lifecycle system 118′ or the lifecycle database 132 until the engineering system 118 or the engineering database 122 goes online. Once the engineering system 118 or the engineering database 122 is online, the information about the creation, amendment, or deletion of the respective first connector 140 may be pushed to the lifecycle system 118′ or the lifecycle database 132 that allows for the creation, amendment or deletion of the respective second connector 142. Corresponding considerations may, e.g., apply in the reverse direction for the creation, amendment, or deletion of the respective first connector 140 if the respective second connector 142 is created, amended or deleted in the lifecycle system 118′ or the lifecycle database 122 while the lifecycle system 118′ or the lifecycle database 132 (or the engineering system 118 or the engineering database 122) is offline. Further, corresponding considerations may, in some examples, apply to the indirect link of the respective lifecycle artifact 134 with the respective engineering artifact 124 via the respective engineering artifact placeholder 136 using the respective second connector 142 that is described in the next paragraphs.

In some examples, the application software component 106 and/or the processor 102 may further be configured to provide a respective engineering artifact placeholder 136 in the lifecycle database 132, the respective engineering artifact placeholder 136 representing the respective engineering artifact 124 in the lifecycle database 132. The respective second connector 142 links the respective lifecycle artifact 134 with the respective engineering artifact 124 via the respective engineering artifact placeholder 136. The link of the respective lifecycle artifact 134 with the respective engineering artifact placeholder 136 is deleted.

In this example, the respective lifecycle artifact 134 stored in the lifecycle database 132 is indirectly linked via the respective second connector 142 with the respective engineering artifact 124 stored in the engineering database 122. The indirect link of the respective lifecycle artifact 134 with the respective engineering artifact 124 via the respective second connector 142 may be established by linking the respective lifecycle artifact 134 with the respective engineering artifact placeholder 136 that is linked with the respective engineering artifact 124.

In some examples, the respective second connector 140 may be deleted by deleting the link of the respective lifecycle artifact 134 with the respective engineering artifact placeholder 136.

In such an example, the lifecycle database 132 or the lifecycle system 118′ may further include the respective engineering artifact placeholder 136 that may be related to the respective lifecycle artifact 134 and the respective engineering artifact 124. Herein, the respective engineering artifact placeholder 136 may at least partly coincide or overlap with the corresponding engineering artifact 124 stored in the engineering database 122. For example, an electric motor may be designed or engineered in the engineering system 118. Components of the electric motor, such as the stator, the rotor, the bearings, etc. including information on their respective geometry or surface quality may be stored both as respective engineering artifacts 124 in the engineering database 122 and as respective engineering artifact placeholder 136 in the lifecycle database 132. The respective second connector 142 may link the respective lifecycle artifact 134, e.g., the geometry requirements of the rotor, with the respective engineering artifact placeholder 136, e.g., the rotor of the electric machine, that is linked with the corresponding engineering artifact 124.

Using such a respective engineering artifact placeholder 136 that is stored in the lifecycle database 132 may, in some examples, facilitate directly or more conveniently managing, e.g., simple aspects of, engineering information 120 in the lifecycle database 132 or the lifecycle system 118′ while still benefiting from comprehensive, professional engineering management through the engineering database 122 or the lifecycle system 118.

Using such a respective engineering artifact placeholder 136 may, in some examples, be particularly beneficial if the engineering database 122 and the lifecycle database 132 may not always be connected to each other with a sufficiently fast data connection allowing for fast data transfer and data synchronization. For example, network interruptions may occur, or a server used for providing the engineering data base 122 or the engineering system 118 and/or the lifecycle database 132 or the lifecycle system 118′ may not always be available. Such unreliable data connection scenarios may make consistency and traceability of engineering-related information very challenging.

Using the above-mentioned respective engineering requirements information 126 in addition to using the respective engineering artifact placeholder 136 may, in some examples, increase the described benefit in the context of a challenging data connection between the engineering database 122 and the lifecycle database 132. This scenario may involve an indirect link using the respective first connector 140 from the respective engineering artifact 124 with the respective lifecycle artifact 134 via the engineering requirements information 126 and may further involve an indirect link using the respective second connector 142 from the respective lifecycle artifact 134 with the respective engineering artifact 124 via the respective engineering artifact placeholder 136.

In further examples, the deletion of the respective second connector 142 may further include deleting the link of the respective engineering artifact placeholder 136 with the respective engineering artifact 124 and/or further include deleting the respective engineering artifact placeholder 136, e.g., if the respective engineering artifact placeholder 136 is no more linked with other lifecycle artifacts 134 and/or with the engineering artifacts 124.

In some examples, the respective engineering artifact placeholder 136 may be known as an ALM surrogate that may be understood as a shadow model of the respective engineering artifact 124 in the lifecycle database 132.

By way of example, if the respective engineering artifact placeholder 136 is no longer linked to any of the lifecycle artifacts 134, the application software component 106 and/or the processor 102 may further be configured to delete the respective engineering artifact placeholder 136.

The respective engineering artifact placeholder 136 may be deleted, e.g., if the respective engineering artifact placeholder 136 is no more directly or indirectly linked to any of the engineering artifacts 122. The deletion of the respective engineering artifact placeholder 136 may help to save storage space in the lifecycle database 132 and to reduce complexity during the engineering of the physical system 150 while keeping engineering information 120 and lifecycle information 130 being related to the physical system 150 up-to-date and consistent.

In some examples, the engineering information 120 and the engineering database 122 are provided to the user as an engineering desktop application, and/or the lifecycle information 130 and the lifecycle database 132 are provided to the user as a lifecycle management desktop application.

Hence, the engineering system 118 and/or the lifecycle management system 118′ may be provided to the user as a corresponding desktop application. Herein, a desktop application may be understood a software program that may be run on a standalone computer to perform a specific task by the user. For example, a desktop application may be developed to run on a specific operating system such as Windows, Mac, or Linux. Further, a desktop application may be designed to run in an isolated environment and may, e.g., be able to work without an internet connection. Therefore, in some examples, the above-mentioned data connection allowing for fast data transfer and data synchronization between the engineering database 122 and the lifecycle database 132 may not always be available if the engineering system 118 and/or the lifecycle management system 118′ may be provided to the user as a corresponding desktop application. Such unreliable data connection scenarios may make consistency and traceability of engineering-related information very challenging.

In many examples, state-of-the-art engineering systems 118 may be provided to the user as a corresponding desktop application so that the above-mentioned unreliable data connection scenarios may occur very frequently.

In some examples, the lifecycle management system 118′ may be provided to the user as web or mobile lifecycle management application. Herein, a web application (or web app) may be understood as an application software that may run on a web server, unlike computer-based software programs that are run locally on the operating system (OS) of the device, such as the above-mentioned desktop applications. Web applications may be accessed by the user through a web browser with an active network connection. These web applications may be programmed using a client-server modeled structure, wherein the user (“client”) may be provided with services through an off-site server that may be hosted by a third-party. Further, a mobile application (or mobile app) may be a computer program or software application designed to run on a mobile device such as a phone, tablet, or watch. Mobile applications may often stand in contrast to the above-mentioned desktop applications that may be designed to run on desktop computers, and web applications that may run in mobile web browsers rather than directly on the mobile device.

A web browser, commonly referred to as a browser, may be understood as application software for accessing the World Wide Web. When a user follows the URL of a web page from a particular website, the web browser may retrieve the necessary content from the website's web server and then display the page on the user's device, e.g., a laptop, smartphone, etc.

In some examples, the engineering UI 116 and/or the lifecycle UI 116′ may be provided to the user in a web browser, e.g., an embedded web browser. In further examples, the engineering UI 116 may be included by the lifecycle UI 116′, e.g., using a window for the engineering UI 116 in the lifecycle UI 116′. In yet further examples, the lifecycle UI 116′ may be included by the engineering UI 116, e.g., using a window for the lifecycle UI 116′ in the engineering UI 116.

In some examples, the respective first connector 140 and/or the respective second connector 142 may include a Uniform Resource Identifier (URI), a Uniform Resource Locator (URL), a Requirements Interchange Format (ReqIF) element, an Open Services for Lifecycle Collaboration (OSLC) element and/or a Resource Description Framework (RDF) element.

Herein, a URI may be understood as a unique sequence of characters that identifies a logical or physical resource used by web technologies. URIs may be used to identify information resources such as web pages or databases. Some URIs provide a locating and retrieving information resources on a network (either on the Internet or on another private network, such as a computer filesystem or an Intranet); these may be Uniform Resource Locators (URLs) that are described in more detail below. A URI may identify the resource by name at the specified location or URL. The web technologies that use URIs are not limited to web browsers. URIs are used to identify anything described using the Resource Description Framework (RDF), for example, concepts that are part of an ontology defined using the Web Ontology Language (OWL).

A Uniform Resource Locator (URL), colloquially termed a web address, may be a reference to a web resource that specifies its location on a computer network and a mechanism for retrieving it. A URL is a specific type of Uniform Resource Identifier (URI). URLs occur most commonly to reference web pages (http) but are also used for file transfer (ftp), email (mailto), database access (JDBC), and many other applications.

the respective first connector 140 or the second connector 142 including a URI or URL may, in some examples, be used for synchronous or for asynchronous communication or operations as explained above in the context of direct or indirect links.

The Requirements Interchange Format (RIF or ReqIF) is an XML file format that may be used to exchange requirements, along with its associated metadata, between software tools from different vendors. The requirements exchange format may also define a workflow for transmitting the status of requirements between partners. Although developed in the automotive industry, ReqIF is suitable for lossless exchange of requirements in any industry.

In some examples, an ReqIF element may always be offline. An ReqIF element may preserve information about the source and target of the link, e.g., the respective first connector 140 or the second connector 142 but cannot ensure the existence of either at time the file or the data is imported in the corresponding target system. This aspect may, in some examples, lead to the creation of items in the target system, e.g., the respective first connector 140 or the second connector 142, that were previously deleted in the source system. This aspect may further lead to ignoring a part of the ReqIF content, e.g., the respective first connector 140 or the second connector 142, as the corresponding target system has no information that the items were deleted in the source system and ignores them on import to the target system.

An Open Services for Lifecycle Collaboration (OSLC) element may be understood as an element corresponding to the OSLC set of specifications that enable integration of software development. OSLC has evolved, and continues to evolve, to areas such as ALM, PLM, IT Operations and more, whereby OSLC intends to make life easier for tools users and tools vendors, by making it easier for tools to work together. Among others, OSLC specifications build on the World Wide Web Consortium (W3C) Resource Description Framework (RDF). RDF has originally been designed as a data model for metadata. It has come to be used as a general method for description and exchange of graph data. RDF provides a variety of syntax notations and data serialization formats with Turtle (Terse RDF Triple Language) currently being the most widely used notation.

In some examples, the respective first connector 140 may include a URL to allow for import or synchronization of lifecycle information 130, e.g., the respective lifecycle artifact 134 or optionally the respective engineering artifact placeholder 136, from the lifecycle database 132 to the engineering database 122. By way of example, the respective first connector 140 may include the web address and/or memory address of the lifecycle database 132 and optionally of the respective lifecycle artifact 134 or the respective engineering artifact placeholder 136 stored in the lifecycle database 132. The respective first connector 140 may further include the web address and/or memory address of the engineering database 122 and for example the web address and/or memory address to which the mentioned lifecycle information 130 is to be imported or synchronized.

By way of example, the respective second connector 142 may include a ReqIF element to allow for import or synchronization of engineering information 120, e.g., the respective engineering artifact 124 or optionally the respective engineering requirements information 126, from the engineering database 122 to the lifecycle database 132.

In some examples, the respective ReqIF element may allow for the desired import, for example with a unique identifier. In further examples, the respective first connector 140 includes a URI or a URL and the respective second connector 142 includes a ReqIF element including the lifecycle information 130 to be imported or synchronized. Herein, the ReqIF element may first be exported from the lifecycle database 132 (when the lifecycle database 132 is available for communication) and then be imported to the engineering database 122 (when the engineering database 122 is available for communication). The respective first connector 140 may therefore be used for synchronous or asynchronous communication as explained above in the context of direct or indirect links, whereas the respective second connector 142 may be used for asynchronous communication between the lifecycle database 132 and the engineering database 122, respectively.

In some examples, the respective lifecycle artifact 134 may be linked with the respective engineering artifact placeholder 136 via a URI that may be included by the respective second connector 142.

Further, in the context of asynchronous communication between the engineering database 122 and the lifecycle database 132, the respective first connector 140 and the respective second connector 142 may include respective a respective URI, URL or a respective ReqIF element. For example, an amendment to the respective engineering artifact 124 (or the respective engineering requirements information 126) may be communicated from the engineering database 122 to the lifecycle database 132 using the respective first connector 140 that may then be used to update the respective lifecycle artifact 134 (or the respective engineering artifact placeholder 136). Conversely, an amendment to the respective lifecycle artifact 134 (or the respective engineering artifact placeholder 136) may be communicated from the lifecycle database 132 to the engineering database 122 using the respective second connector 142 that may then be used to update the respective engineering artifact 124 (or the respective engineering requirements information 126).

In some examples, the first connector 140 and/or the second connector 142 may include or be embodied by a hyperlink that may be understood as a reference to data that the user may follow by clicking or tapping.

By way of example, the application software component 106 and/or the processor 102 may further be configured to display a UI element 170 indicating the intended deletion of the respective second connector 142 in an engineering user interface (UI) 116; to capture a user's intent to confirm or reject the intended deletion of the respective second connector 142 in response to user interactions with the engineering UI 116) and to delete the respective second connector 142 if the captured user's intent corresponds to a confirmation of the intended deletion of the respective second connector 142.

Displaying an information about the intended deletion of the respective second connector 142 to the user and capturing the user's feedback may provide additional control to the user and may help to avoid an avoided deletion of information. The user may then confirm or reject the intended deletion, whereby the respective second connector 142 may only be deleted if the user has confirmed the intended deletion by importing corresponding information via the engineering UI 116.

In some examples, the application software component 106 and/or the processor 102 may further be configured to engineer, model, simulate and/or analyze the physical system 150 using the engineering information 120 and the lifecycle information 130.

Hence, in some examples, a simulation of the physical system 150 may be carried out taking into account the engineering information 120 and the lifecycle information 130. In some examples, if the respective first connector 140 and the respective second connector 142 are deleted, the engineering information 120 or the lifecycle information 130 of the physical system 150 may have been changed. The changed engineering information 120 or lifecycle information 130 may, e.g., relate to an amended property or an amended requirement of the physical system 150, such as a lower weight, smaller size, a higher output power, etc., of the physical system 150. This amendment may, in some examples, be used as a boundary condition which the physical system 150 may need to comply with and one or more simulations may be run, e.g., with varying engineering information 120 to find amended engineering information that characterizes a physical system 150 complying with the amendment. Analogously, modeling, analyzing, or engineering the physical system 150 may be done taking into account the amendment in order to obtain amended engineering information that characterizes a physical system 150 complying with the amended requirement.

Engineering, modeling, simulating and/or analyzing the physical system 150 may, by way of example, include considering the time-varying behavior of the dynamical, physical system 150. Such physical systems 150 may, e.g., be described by ordinary differential equations or partial differential equations. A simulation or calculation run may solve the state-equation system to find the behavior of the state variables over a specified period of time. The equation(s) may be solved through numerical integration methods to produce the transient behavior of the state variables. Simulation of dynamic physical systems 150 may predict the values of model-system state variables, as they are determined by the past state values. This relationship may be described or characterized by an according model of the physical system 150.

In some examples, the application software component 106 and/or the processor 102 may further be configured to measure or determine the engineering information 120 of the physical system 150, e.g., using a sensor, CAD data, communication data, etc. relating to the physical system 150.

By way of example, some or all of the engineering information 120, e.g., the respective engineering artifact 124, may be measured or determined using a sensor that may, e.g., be suitable to measure or determine the respective engineering information 120, such as mechanical, thermal, etc. information of the physical system 150. Further, some or all of the engineering information 120 may be measured or determined using CAD data that may, e.g., determined, and in some cases read in, using a specification plate, e.g., an electronic specification plate, of the physical system 150. Herein, the (electronic) specification plate may include the CAD data or a sort of link that allows to access or download the CAD data. In further examples, some or all of the engineering information 120 may be measured or determined using communication data of the physical system 150 that is communicatively coupled to another device. Herein, the communication data may, e.g., be used to determine control information or process-oriented information of the physical system 150.

In some examples, some or all of the engineering information 120 may be measured or determined using the respective (real) physical system 150 as indicated in FIG. 1 with the dashed line connecting the processor 102 of the engineering system 118 with the physical system 150.

The suggested approach for facilitating engineering a physical system which for example involving an enhanced consistency of engineering-related information may offers several advantages. The suggested approach offers users engineering a physical system 150 and connected an automated way to find and remove inconsistencies, for example to remove unnecessary or outdated data from the lifecycle database 122 or the lifecycle system 118′. This removal unnecessary or outdated data may include links, hyperlinks and/or objects themselves.

This is of great value to such users working with an engineering system 118 and a related lifecycle system 118′. The suggested approach is very convenient for the users, e.g., by requiring far less clicks by the user and hence requiring a lot less time. Further, the suggested approach is less error-prone than other approaches. In addition, the overall consistency of the engineering information 120 and the lifecycle information 130 of a physical system 150 may be improved since a reliable traceability may be established in both the engineering system 118 and a related lifecycle system 118′ so that both engineering system 118 and the related lifecycle system 118′ may serve as point of trust.

In some examples of the above-described asynchronous operation, a synchronization may be done periodically, e.g., once per minute, hour, or day, or event-triggered, e.g., if a certain threshold of an amount of data that is to be communicated is exceeded.

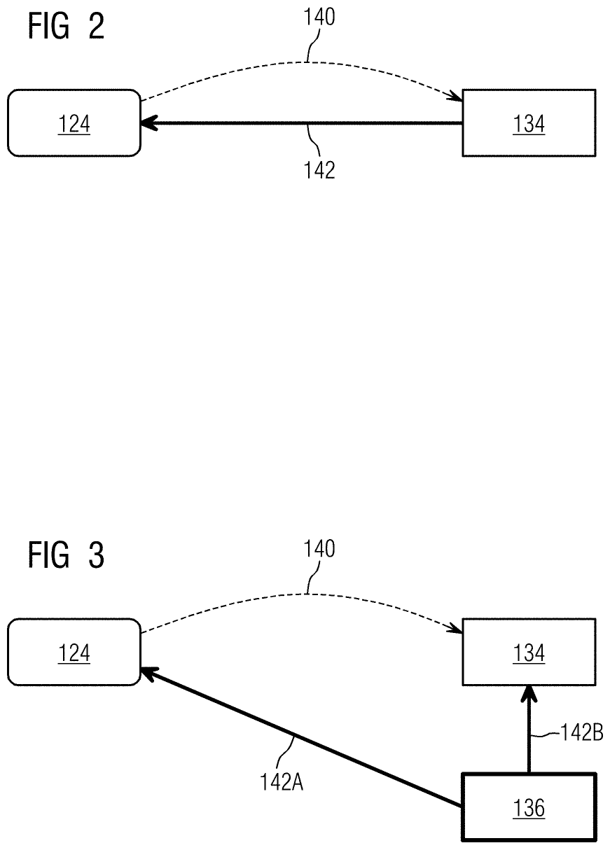

Referring now to FIG. 2, a first example scenario of engineering information 120, lifecycle information 130 and connectors 140, 142 in the context of facilitating engineering a physical system 150 is depicted, for example involving enhanced consistency of engineering-related information, in a product system.

In this example scenario, an engineering artifact 124 stored in the engineering database 122 is directly linked via a first connector 140 with a lifecycle artifact 134 stored in the lifecycle database 132. Further, the lifecycle artifact 134 is directly linked via a second connector 142 with the engineering artifact 124. If the first connector 140 is deleted, then the second connector 142 is also deleted.

Herein, the initial deletion of the first connector 140 is indicated in FIG. 2 with the dashed line, whereas the subsequent deletion of the second connector 142 is indicated in the FIG. 2 with the bold line. This scheme of initial deletions indicated with the dashed line and of subsequent deletions indicated with a bold line is also used in FIGS. 3 to 7.

Referring now to FIG. 3, a second example scenario of engineering information 120, lifecycle information 130 and connectors 140, 142 in the context of facilitating engineering a physical system 150 is depicted, for example involving enhanced consistency of engineering-related information, in a product system.

In this example scenario, the engineering artifact 124 is directly linked via the first connector 140 with the lifecycle artifact 134, whereas the lifecycle artifact 134 is only indirectly linked via a second connector 142 with the engineering artifact 124. The indirect link of the lifecycle artifact 134 with the engineering artifact 124 is achieved by linking the lifecycle artifact 134 with an engineering artifact placeholder 136 (cf. arrow 142B) that is linked with the engineering artifact 124 (cf. arrow 142A).

If the first connector 140 is deleted, then the second connector 142 is also deleted, in this scenario involving the deletion of both the link 142B of the lifecycle artifact 134 with the engineering artifact placeholder 136 and of the link 142A of the engineering artifact placeholder 136 with the engineering artifact 124. Further, the engineering artifact placeholder 136 may be deleted since the engineering artifact placeholder 136 has no more links to other engineering artifacts 124 or to other lifecycle artifacts 134.

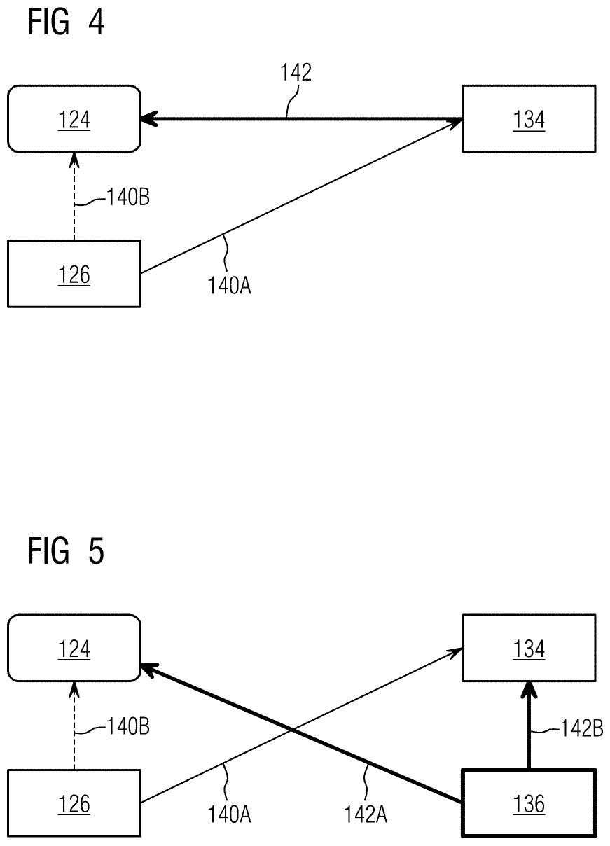

Referring now to FIG. 4, a third example scenario of engineering information 120, lifecycle information 130 and connectors 140, 142 in the context of facilitating engineering a physical system 150 is depicted, for example involving enhanced consistency of engineering-related information, in a product system.

In this example scenario, the engineering artifact 124 is only indirectly linked via the first connector 140 with the lifecycle artifact 134, whereas the lifecycle artifact 134 is directly linked via a second connector 142 with the engineering artifact 124. The indirect link of engineering artifact 124 the lifecycle artifact 134 is achieved by linking the engineering artifact 124 with an engineering requirements information 126 (cf. arrow 140B) that is linked with the lifecycle artifact 134 (cf. arrow 140A).

As depicted in FIG. 4, the link 140B of the engineering artifact 124 with the engineering requirements information 126 is deleted that means that the first connector 140 is deleted. In this case, the second connector 142 is also deleted. In some examples, the link 140A of the engineering requirements information 126 with the engineering artifact 124 may also be deleted.

Referring now to FIG. 5, a fourth example scenario of engineering information 120, lifecycle information 130 and connectors 140, 142 in the context of facilitating engineering a physical system 150 is depicted, for example involving enhanced consistency of engineering-related information, in a product system.

This example scenario corresponds to a combination of the second and the third scenario depicted in FIGS. 3 and 4 and described above. Here, the engineering artifact 124 is only indirectly linked via the first connector 140 with the lifecycle artifact 134, and the lifecycle artifact 134 is only indirectly linked via a second connector 142 with the engineering artifact 124. The indirect link of engineering artifact 124 the lifecycle artifact 134 is achieved by linking the engineering artifact 124 with an engineering requirements information 126 (cf. arrow 140B) that is linked with the lifecycle artifact 134 (cf. arrow 140A). The indirect link of the lifecycle artifact 134 with the engineering artifact 124 is achieved by linking the lifecycle artifact 134 with an engineering artifact placeholder 136 (cf. arrow 142B) that is linked with the engineering artifact 124 (cf. arrow 142A).

As depicted in FIG. 5, the link 140B of the engineering artifact 124 with the engineering requirements information 126 is deleted that means that the first connector 140 is deleted. In this case, the second connector 142 is also deleted, in this scenario involving the deletion of both the link 142B of the lifecycle artifact 134 with the engineering artifact placeholder 136 and of the link 142A of the engineering artifact placeholder 136 with the engineering artifact 124. Further, the engineering artifact placeholder 136 may be deleted since the engineering artifact placeholder 136 has no more links to other engineering artifacts 124 or to other lifecycle artifacts 134. In some examples, the link 140A of the engineering requirements information 126 with the engineering artifact 124 may also be deleted.

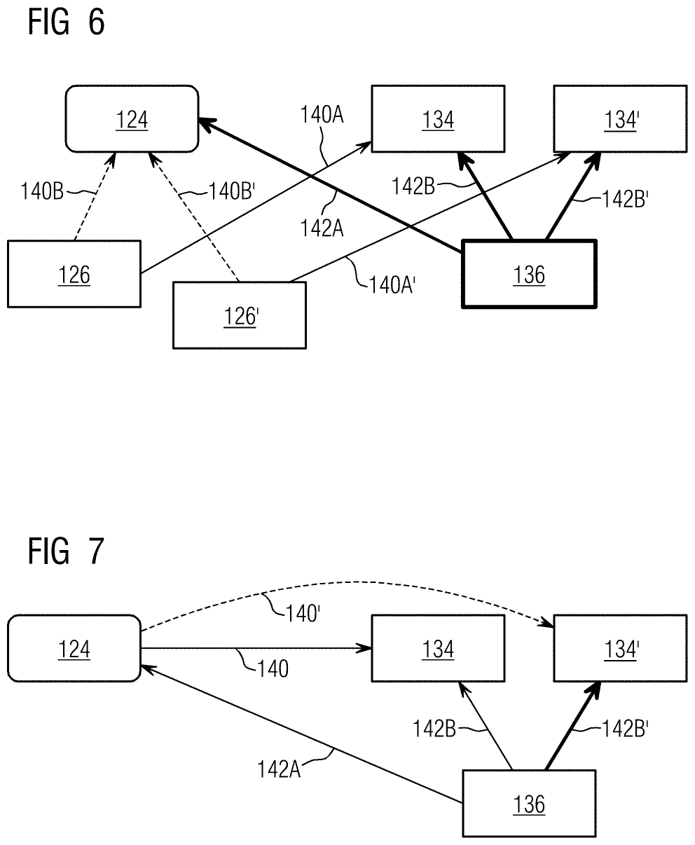

Referring now to FIG. 6, a fifth example scenario of engineering information 120, lifecycle information 130 and connectors 140, 142 in the context of facilitating engineering a physical system 150 is depicted, for example involving enhanced consistency of engineering-related information, in a product system.

In this scenario, on the engineering side, there is one engineering artifact 124 that is related to two engineering requirements information items 126, 126′. Further, on the lifecycle management side, there are two lifecycle artifacts 134, 134′ that are related to one engineering artifact placeholder 136. Hereby, the respective lifecycle artifact 134, 134′ has some correspondence in the respective engineering requirements information item 126, 126′. Further, the engineering artifact 124 has some correspondence in the engineering artifact placeholder 136.

As depicted in FIG. 6, the respective link 140B, 140B′ of the respective engineering artifact 124, 124′ with the respective engineering requirements information item 126, 126′ is deleted that means that the respective first connector 140, 140′ is deleted. In this case, the respective second connector 142, 142′ is also deleted, in this scenario involving the deletion of both the links 142B, 142B′ of the respective lifecycle artifact 134, 134′ with the engineering artifact placeholder 136 and of the link 142A of the engineering artifact placeholder 136 with the engineering artifact 124. Further, the engineering artifact placeholder 136 may be deleted since the engineering artifact placeholder 136 has no more links to other engineering artifacts 124 or to other lifecycle artifacts 134. In some examples, the respective link 140A, 140A′ of the respective engineering requirements information items 126, 126′ with the engineering artifact 124 may also be deleted.

Referring now to FIG. 7, a sixth example scenario of engineering information 120, lifecycle information 130 and connectors 140, 142 in the context of facilitating engineering a physical system 150 is depicted, for example involving enhanced consistency of engineering-related information, in a product system.

In this example scenario, the engineering artifact 124 is directly linked via the respective first connector 140, 140′ with the respective lifecycle artifact 134, 134′, whereas the respective lifecycle artifact 134, 134 is only indirectly linked via the respective second connector 142, 142′ with the engineering artifact 124. The respective indirect link of the respective lifecycle artifact 134, 134′ with the engineering artifact 124 is achieved by linking the respective lifecycle artifact 134, 134′ with the engineering artifact placeholder 136 (cf. respective arrow 142B, 142B′) that is linked with the engineering artifact 124 (cf. arrow 142A).

If the first connector 140′ linking the engineering artifact 124 with the lifecycle artifact 134′, is deleted, then the second connector 142 linking this lifecycle artifact 134′ with the engineering artifact 124 is also deleted, in this scenario involving the deletion of link 142B′ of the lifecycle artifact 134′ with the engineering artifact placeholder 136. The link 142A of the engineering artifact placeholder 136 with the engineering artifact 124 may, however, not be deleted since it is also used for linking the lifecycle artifact 134 via the engineering artifact placeholder 136 with the engineering artifact 124. Further, the engineering artifact placeholder 136 needs to be kept because the lifecycle artifact 134 continues to be linked via the engineering artifact placeholder 136 with the engineering artifact 124.

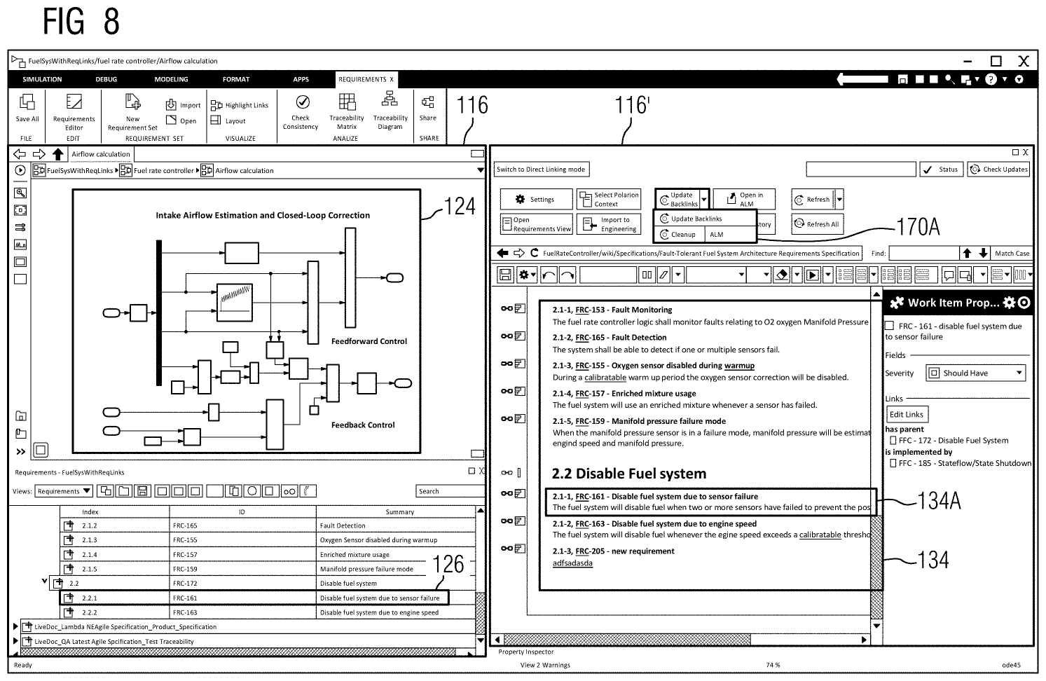

Referring now to FIG. 8, a sample UI is depicted that facilitates engineering a physical system 150, for example involving enhanced consistency of engineering-related information, in a product system.

The depicted UI includes an engineering UI 116 and lifecycle management UI 116′, wherein some engineering artifacts 124 and related engineering requirements information 126 is displayed in the engineering UI 116. Lifecycle artifacts 134 corresponding to the engineering artifacts 124 are displayed in the lifecycle management UI 116′, wherein the lifecycle artifact 134A may related to the engineering requirements information 126 as both mention “Disable fuel system due to the sensor failure”.

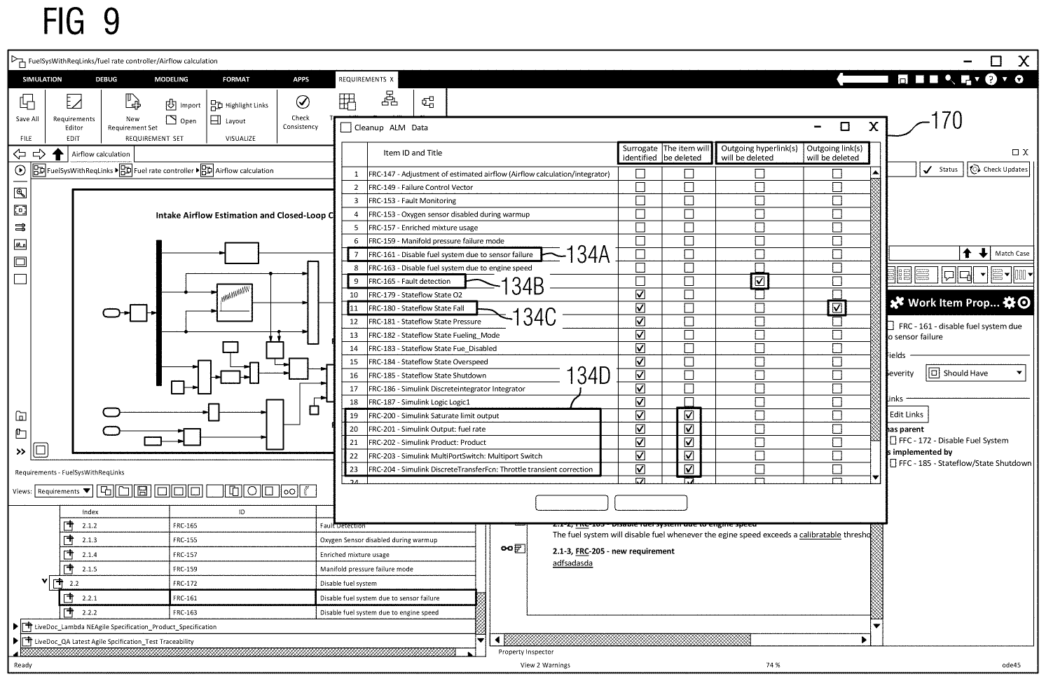

The UI may include a UI element 170 that may be used to indicate the intended deletion of a second connector 142 connecting the lifecycle artifact 134A with the corresponding engineering artifact 124. In FIG. 8, this UI element 170 is accessible via the button “Update Backlinks” and the selection of the option “Cleanup ALM” as indicated with reference sign 170A. The UI element 170 is depicted in FIG. 9 and explained in more detail below.

Referring now to FIG. 9, another sample UI is depicted that facilitates engineering a physical system 150, for example involving enhanced consistency of engineering-related information, in a product system. Herein, FIG. 9 shows the sample UI of FIG. 8, now including the UI element 170 explained above.

After selecting the option “Cleanup ALM”, the UI element 170 is displayed in the UI to the user. The UI element 170 lists several lifecycle artifacts 134 including the above-mentioned lifecycle artifacts 134A, and some additional lifecycle artifacts 134B, 134C, and 134D. As depicted in the UI element 170, for the lifecycle artifact 134B an outgoing hyperlink is suggested to be deleted. This outgoing hyperlink may be included or be the corresponding second connector 142B linking the lifecycle artifact 134B with a corresponding engineering artifact 124. Further, the UI element 170 lists for the lifecycle artifact 134C that an outgoing link is suggested to be deleted. This outgoing link may be included or be the corresponding second connector 142 linking the lifecycle artifact 134C with a corresponding engineering artifact 124. The UI element 170 also lists for the lifecycle artifacts 134D that a corresponding surrogate has been found and is suggested to be deleted. Herein, the surrogate may correspond to the above-explained engineering artifact placeholder 136. This surrogate may be used for the corresponding respective second connector 142C linking the respective lifecycle artifact 134C with a corresponding engineering artifact 124.

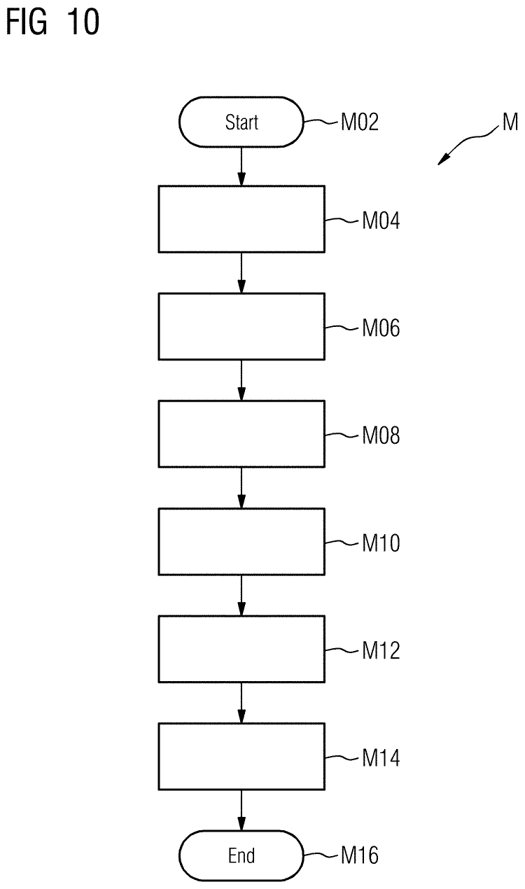

Referring now to FIG. 10, a flow diagram of an example methodology is depicted that facilitates engineering a physical system, for example involving enhanced consistency of engineering-related information, in a product system. The methodology M may start at M02 and may include several acts carried out through operation of at least one processor.

These acts may include an act M04 of providing engineering information in an engineering database, the engineering information being related to physical, mechanical, electrical, electronic, hydraulic, thermal, control, electric power and/or process-oriented information of the physical system; an act M06 of providing lifecycle information in a lifecycle database, the lifecycle information being related to the conception, requirements, uses cases, issues, design, realization and/or service information of the physical system; an act M08 of providing a respective first connector for connecting a respective engineering artifact included by the engineering information directly or indirectly with a respective lifecycle artifact included by the lifecycle information, wherein the respective first connector is stored in the engineering database; an act M10 of providing a respective second connector for connecting the respective lifecycle artifact directly or indirectly with the respective engineering artifact, wherein the respective second connector is stored in the lifecycle database; an act M12 of providing a deletion of the respective first connector; and an act M14 of deleting the respective second connector. At M16 the methodology may end.

The methodology M may include other acts and features discussed previously with respect to the computer-implemented method of engineering a physical system 150, for example involving enhanced consistency of engineering-related information.

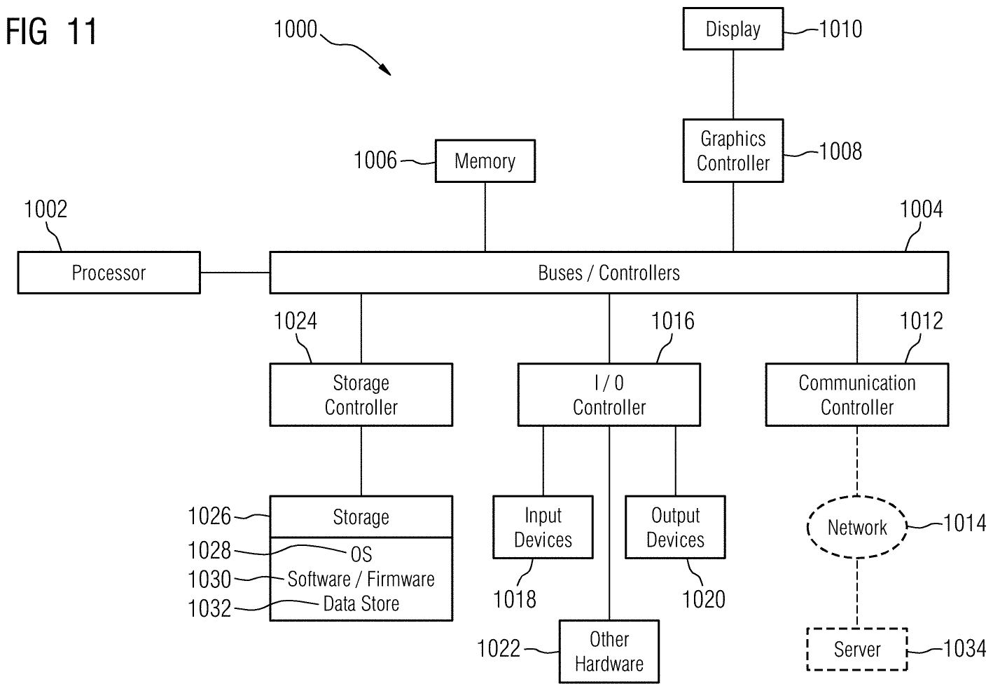

FIG. 11 depicts a block diagram of a data processing system 1000 (also referred to as a computer system) in which an embodiment may be implemented, for example, as a portion of a product system, and/or other system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 1012 (Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (connected to speakers and/or microphones). Various peripherals may be connected to the I/O controller(s) (via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, many devices referred to as input devices or output devices may both provide inputs and receive outputs of communications with the data processing system. For example, the processor 1002 may be integrated into a housing (such as a tablet) that includes a touch screen that serves as both an input and display device. Further, some input devices (such as a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, that may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, that is retrievable by a processor.

The communication controllers 1012 may be connected to the network 1014 (not a part of data processing system 1000), that may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

Further, the term “controller” means any device, system, or part thereof that controls at least one operation, whether such a device is implemented in hardware, firmware, software, or some combination of at least two of the same. It should be noted that the functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, it should be noted that the processor described herein may be located in a server that is remote from the display and input devices described herein. In such an example, the described display device and input device may be included in a client device that communicates with the server (and/or a virtual machine executing on the server) through a wired or wireless network (that may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, that may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, it should be understood that the words or phrases used herein should be construed broadly, unless expressly limited in some examples. For example, the terms “comprise” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather these numeral adjectives are used to distinguish different elements, functions or acts from each other. For example, a first element, function, or act could be termed a second element, function, or act, and, similarly, a second element, function, or act could be termed a first element, function, or act, without departing from the scope of the present disclosure.

In addition, phrases such as “processor is configured to” carry out one or more functions or processes, may mean the processor is operatively configured to or operably configured to carry out the functions or processes via software, firmware, and/or wired circuits. For example, a processor that is configured to carry out a function/process may correspond to a processor that is executing the software/firmware, that is programmed to cause the processor to carry out the function/process and/or may correspond to a processor that has the software/firmware in a memory or storage device that is available to be executed by the processor to carry out the function/process. It should also be noted that a processor that is “configured to” carry out one or more functions or processes, may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may mean: that an element is relatively near to but not in contact with a further element; or that the element is in contact with the further portion, unless the context clearly indicates otherwise.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of engineering a physical system, the method comprising:
providing engineering information in an engineering database, the engineering information being related to physical, mechanical, electrical, electronic, hydraulic, thermal, control, electric power and/or process-oriented information of the physical system;
providing lifecycle information in a lifecycle database, the lifecycle information being related to a conception, requirements, uses cases, issues, design, realization and/or service information of the physical system;
providing a respective first connector for connecting a respective engineering artifact comprised by the engineering information directly or indirectly with a respective lifecycle artifact comprised by the lifecycle information, wherein the respective first connector is stored in the engineering database;
providing a respective second connector for connecting the respective lifecycle artifact directly or indirectly with the respective engineering artifact, wherein the respective second connector is stored in the lifecycle database;
providing a deletion of the respective first connector; and
deleting the respective second connector.

2. The computer-implemented method of claim 1, wherein the respective first connector directly links the respective engineering artifact with the respective lifecycle artifact.

3. The computer-implemented method of claim 1, further comprising:
providing respective engineering requirements information related to the respective engineering artifact in the engineering database, the respective engineering requirements information being related to the conception, requirements, uses cases, issues, design, realization and/or service information of the physical system;
wherein the respective first connector links the respective engineering artifact with the respective lifecycle artifact via the respective engineering requirements information; and
wherein the link of the respective engineering artifact with the respective engineering requirements information is deleted.

4. The computer-implemented method of claim 1, wherein the respective second connector directly links the respective lifecycle artifact with the respective engineering artifact.

5. The computer-implemented method of claim 1, further comprising:
providing a respective engineering artifact placeholder in the lifecycle database, the respective engineering artifact placeholder representing the respective engineering artifact in the lifecycle database;
wherein the respective second connector links the respective lifecycle artifact with the respective engineering artifact via the respective engineering artifact placeholder;
wherein the link of the respective lifecycle artifact with the respective engineering artifact placeholder is deleted.

6. The computer-implemented method of claim 5, further comprising, when the respective engineering artifact placeholder is no longer linked to any of the lifecycle artifacts: deleting the respective engineering artifact placeholder.

7. The computer-implemented method of claim 1, wherein the engineering information and the engineering database are provided to a user as an engineering desktop application, and/or wherein the lifecycle information and the lifecycle database are provided to the user as a lifecycle management desktop application.

8. The computer-implemented method of claim 1, wherein the respective first connector and/or the respective second connector comprises a Uniform Resource Identifier (URI), a Uniform Resource Locator (URL), a Requirements Interchange Format (ReqIF) element, an Open Services for Lifecycle Collaboration (OSLC) element and/or a Resource Description Framework (RDF) element.

9. The computer-implemented method of claim 1, further comprising:
displaying a UI element indicating the intended deletion of the respective second connector in an engineering user interface;
capturing a user's intent to confirm or reject the intended deletion of the respective second connector in response to user interactions with the engineering user interface; and
deleting the respective second connector if the captured user's intent corresponds to a confirmation of the intended deletion of the respective second connector.

10. The computer-implemented method of claim 1, further comprising:
engineering, modeling, simulating and/or analyzing the physical system using the engineering information and the lifecycle information.

11. The computer-implemented method of claim 1, further comprising:
measuring or determining the engineering information of the physical system using a sensor, CAD data, or communication data relating to the physical system.

12. A non-transitory computer implemented storage medium, including machine-readable instructions stored therein, that when executed by at least one processor, cause the processor to:
provide engineering information in an engineering database, the engineering information being related to physical, mechanical, electrical, electronic, hydraulic, thermal, control, electric power and/or process-oriented information of a physical system;
provide lifecycle information in a lifecycle database, the lifecycle information being related to a conception, requirements, uses cases, issues, design, realization and/or service information of the physical system;
provide a respective first connector for connecting a respective engineering artifact comprised by the engineering information directly or indirectly with a respective lifecycle artifact comprised by the lifecycle information, wherein the respective first connector is stored in the engineering database;
provide a respective second connector for connecting the respective lifecycle artifact directly or indirectly with the respective engineering artifact, wherein the respective second connector is stored in the lifecycle database;
provide a deletion of the respective first connector; and
delete the respective second connector.

13. The non-transitory computer implemented storage medium of claim 12, wherein the respective first connector directly links the respective engineering artifact with the respective lifecycle artifact.

14. The non-transitory computer implemented storage medium of claim 12, wherein the machine-readable instructions further comprise instructions, that when executed by at least one processor, cause the processor to:
provide respective engineering requirements information related to the respective engineering artifact in the engineering database, the respective engineering requirements information being related to the conception, requirements, uses cases, issues, design, realization and/or service information of the physical system;
wherein the respective first connector links the respective engineering artifact with the respective lifecycle artifact via the respective engineering requirements information; and
wherein the link of the respective engineering artifact with the respective engineering requirements information is deleted.

15. The non-transitory computer implemented storage medium of claim 12, wherein the respective second connector directly links the respective lifecycle artifact with the respective engineering artifact.

16. The non-transitory computer implemented storage medium of claim 12, wherein the machine-readable instructions further comprise instructions, that when executed by at least one processor, cause the processor to:
provide a respective engineering artifact placeholder in the lifecycle database, the respective engineering artifact placeholder representing the respective engineering artifact in the lifecycle database;
wherein the respective second connector links the respective lifecycle artifact with the respective engineering artifact via the respective engineering artifact placeholder;
wherein the link of the respective lifecycle artifact with the respective engineering artifact placeholder is deleted.

17. The non-transitory computer implemented storage medium of claim 16, wherein the machine-readable instructions further comprise instructions, that when executed by at least one processor and when the respective engineering artifact placeholder is no longer linked to any of the lifecycle artifacts, cause the processor to: delete the respective engineering artifact placeholder.

18. The non-transitory computer implemented storage medium of claim 12, wherein the engineering information and the engineering database are provided to a user as an engineering desktop application, and/or wherein the lifecycle information and the lifecycle database are provided to the user as a lifecycle management desktop application.

19. The non-transitory computer implemented storage medium of claim 12, wherein the respective first connector and/or the respective second connector comprises a Uniform Resource Identifier (URI), a Uniform Resource Locator (URL), a Requirements Interchange Format (ReqIF) element, an Open Services for Lifecycle Collaboration (OSLC) element and/or a Resource Description Framework (RDF) element.

20. The non-transitory computer implemented storage medium of claim 12, wherein the machine-readable instructions further comprise instructions, that when executed by at least one processor, cause the processor to:
display a UI element indicating the intended deletion of the respective second connector in an engineering user interface;
capture a user's intent to confirm or reject the intended deletion of the respective second connector in response to user interactions with the engineering user interface; and
delete the respective second connector if the captured user's intent corresponds to a confirmation of the intended deletion of the respective second connector.
